(19) United States
(12) Patent Application Publication
(10) Pub. No.: US 2009/0094310 A1
(43) Pub. Date: Apr. 9, 2009

(54) PARALLEL COMPUTING SYSTEM AND PARALLEL COMPUTING METHOD

(75) Inventors: Yoichi WATANABE, Ashigarakami-gun (JP); Hideki OKAMOTO, Ashigarakami-gun (JP); Nobuyuki HIROOKA, Ashigarakami-gun (JP); Tomohiro SEKO, Ashigarakami-gun (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/183,743

(22) Filed: Jul. 31, 2008

(30) Foreign Application Priority Data
Oct. 3, 2007 (JP) 2007-259422

(51) Int. Cl. G06F 15/16; G06F 12/00

(52) U.S. Cl. 709/201

(57) ABSTRACT

The parallel computing system is provided with: plural computing nodes that perform a computation; a management node that is connected to the plural computing nodes, and that manages parallel computing by the plural computing nodes; and an external memory that is connected to the management node, that is accessible from the management node and the plural computing nodes, and that uses a semiconductor memory as a memory medium. The management node allocates data to be processed to each of the computing nodes, and creates an individual data file for each of the computing nodes in the external memory, and each of the computing nodes performs a computation by accessing the external memory and by reading the data file allocated to itself and a different data file to be referenced in a computation using the allocated data file, and outputs a computation result to the external memory.

### CROSS REFERENCE TO RELATED APPLICATIONS

This application is based on and claims priority under 35 USC §119 from Japanese Patent Application No. 2007-259422 filed Oct. 3, 2007.

### BACKGROUND

1. Technical Field

The present invention relates to a parallel computing system and a parallel computing method.

2. Related Art

Parallel computing is often used to perform a large amount of computation, for example, in a large-scale analysis. In the parallel computing, the analysis is performed by plural computers through distributed processing Such parallel computing is performed on a cluster, in which plural computers are connected to each other through a network, by executing an analysis program using a parallel library such as a message-passing interface (MPI), for example. In this case, a hard disk drive (HDD) is generally used as an external memory of the computers. Moreover, a virtual memory management method for a multi-processor system in which plural processors operate in parallel while communicating and cooperating with each other is used as a memory system for plural computers.

### SUMMARY

According to an aspect of the invention, there is provided a parallel computing system including: plural computing nodes that perform a computation; a management node that is connected to the plural computing nodes, and that manages parallel computing by the plural computing nodes; and an external memory that is connected to the management node, that is accessible from the management node and the plural computing nodes, and that uses a semiconductor memory as a memory medium. The management node allocates data to be processed to each of the computing nodes, and creates an individual data file for each of the computing nodes in the external memory, and each of the computing nodes performs a computation by accessing the external memory and by reading the data file allocated to itself and a different data file to be referenced in a computation using the allocated data file, and outputs a computation result to the external memory.

### BRIEF DESCRIPTION OF THE DRAWINGS

Exemplary embodiment(s) of the present invention will be described in detail based on the following figures, wherein:

FIG. 1 is a diagram showing an entire configuration of a parallel computing system according to the first exemplary embodiment;

FIG. 2 is a diagram showing an example of a hardware configuration of the computer for realizing the management node and the computing nodes;

FIG. 3 is a diagram showing a functional configuration of the management node;

FIG. 4 is a diagram showing a functional configuration of each of the computing nodes;

FIG. 5 is a flowchart for explaining overall operations of the parallel computing system by taking, as an example, a case of performing an analysis of behavior on particles by a distinct element method;

FIG. 6 is a view showing an example of the data structure of a particle information file;

FIG. 7 is a table showing a state in which particles are allocated to the computing nodes;

FIG. 8 is a flowchart for explaining overall operations of the parallel computing system by taking, as an example, a case of performing an analysis by a finite element method;

FIG. 9 a diagram showing a configuration of the parallel computing system according to the second exemplary embodiment;

FIG. 10 is a diagram showing a functional configuration of the management node;

FIG. 11 is a diagram showing a functional configuration of each of the computing nodes;

FIG. 12 is a flowchart for explaining overall operations of the parallel computing system by taking, as an example, a case of performing an analysis of behavior on particles by a distinct element method; and

FIG. 13 is a flowchart for explaining overall operations of the parallel computing system by taking, as an example, a case of performing a finite element analysis.

### DETAILED DESCRIPTION

Hereinafter, with reference to the attached drawings, a detailed description will be given of exemplary embodiments for carrying out the present invention.

### First Exemplary Embodiment

### <System Configuration>

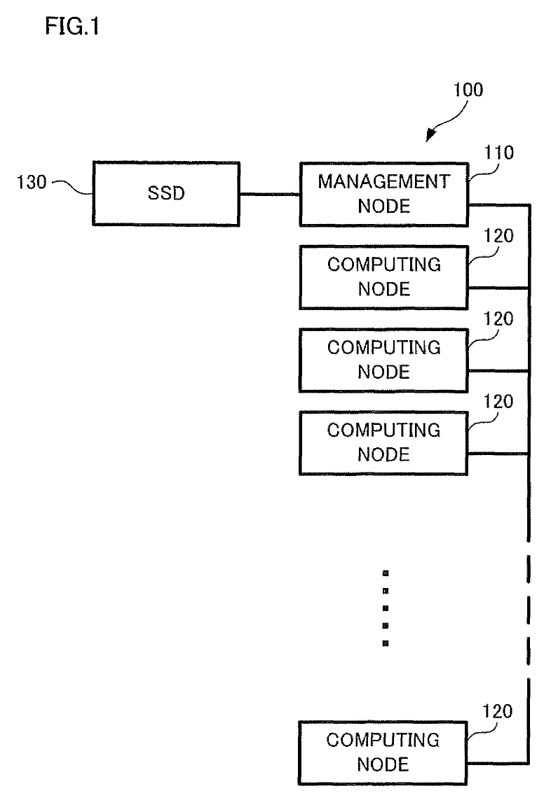

FIG. 1 is a diagram showing an entire configuration of a parallel computing system according to the first exemplary embodiment.

The parallel computing system 100 shown in FIG. 1 is provided with a single management node 110, plural computing nodes 120, a solid state drive (SSD) 130 that is an external memory connected to the management node 110. Each of the nodes (the management node 110 and the computing nodes 120) is connected to the network, and thereby a so-called cluster computing is established. Each node is realized by a computer such as a personal computer, a work station or the like. The SSD 130 uses a semiconductor memory such as a dynamic random access memory (DRAM), a flash memory or the like as a memory medium, and the SSD 130 is used as an external memory of the computer, similarly to a hard disk drive (HDD) or the like. Since the semiconductor memory is used as a memory medium in the SSD 130, the SSD 130 does not require time for moving a head and increasing a rotation number of the disk when reading or writing data, which is required by the HDD.

In the first exemplary embodiment, a description will be given of a case in which an analysis of behavior on particles is performed, as an example of computing (analysis processing) by the parallel computing system 100. Specifically, the first exemplary embodiment is applied to a case in which an analysis is performed by simulating behavior of particles in the state where plural types of particles (toner, carrier particles and the like) are mixed, like an image forming material used for image formation in an image forming apparatus with an electrophotographic system, for example.

In such an analysis, a distinct element method or a finite element method is used. It should be noted that the analysis of behavior on particles is only an example of the processing to which the first exemplary embodiment may be applied. Further, the first exemplary embodiment may be applied to various kinds of processings in which a distributed processing may be performed by the parallel computing.

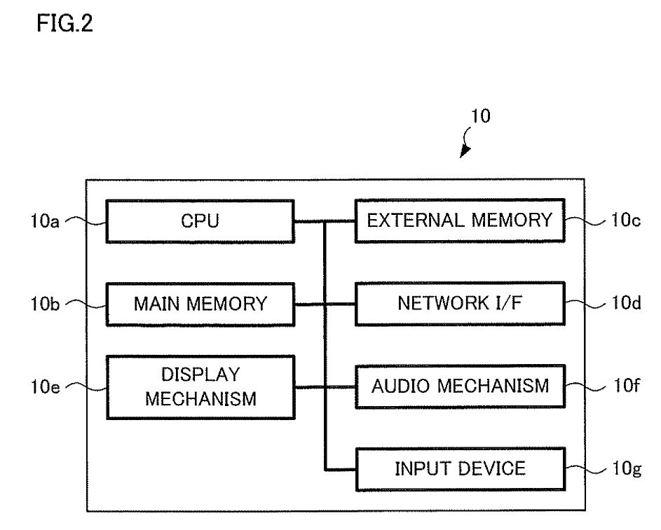

FIG. 2 is a diagram showing an example of a hardware configuration of the computer for realizing the management node 110 and the computing nodes 120.

The computer 10 shown in FIG. 2 is provided with a central processing unit (CPU) 10a as a computing unit, a main memory 10b and an external memory 10c as a memory. A magnetic disk apparatus (HDD: hard disk drive) is generally used as the external memory 10c, but the SSD 130 is used as the external memory 10c in the management node 110. Further, the computer 10 in FIG. 2 is provided with a network interface (network I/F) 10d for connection with an external apparatus through the network, a display mechanism 10e for display output to the display, and an audio mechanism 10f for audio output. Furthermore, the computer 10 is provided with an input device 10g such as a keyboard, a mouse or the like. The CPU 10a and each of the other components are connected to each other through a chip set or a bridge circuit that is not shown in the figure.

In FIG. 2, the components are connected to each other through various kinds of buses such as a system bus and an input and output bus. For example, the CPU 10a is connected to the main memory 10b through a system bus or a memory bus. Further, the CPU 10a is connected to the external memory 10c, the network I/F 10d, the display mechanism 10e, the audio mechanism 10f, the input device 10g and the like through the input and output buses such as a peripheral components interconnect (PCI), a PCI Express, a serial AT attachment (serial ATA), a universal serial bus (USB) and an accelerated graphics port (AGP).

It should be noted that FIG. 2 only shows an example of the hardware configuration of the preferable computer for realizing the management node 110 and the computing nodes 120 constituting the parallel computing system 100, and the configuration is not limited to that shown in the figure. For example, as an auxiliary memory of the computing node 120, a drive that uses a flexible disk or an optical disk as a medium, or a USB memory may be provided in addition to the external memory 10c. The USE memory is to be connected to the bridge circuit through the USB. Moreover, the audio mechanism 10f may be provided as a function of the chip set instead of having an independent configuration.

### <Functions of Nodes>

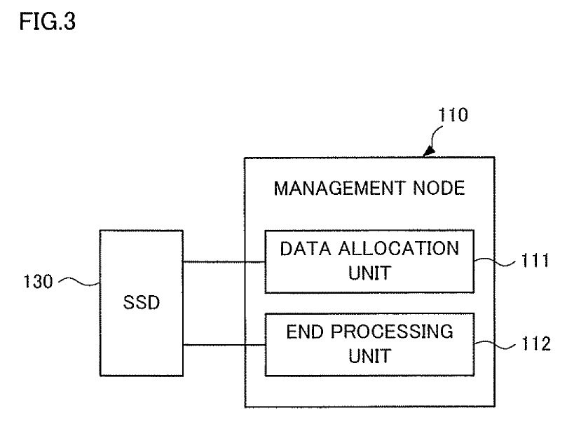

FIG. 3 is a diagram showing a functional configuration of the management node 110.

As shown in FIG. 3, the management node 110 is provided with a data allocation unit 111 that allocates data to be analyzed to each of the computing nodes 120, and an end processing unit 112 that performs an end processing after computations are completed by all the computing nodes 120. The data allocation unit 111 and the end processing unit 112 are functions realized through execution of a program, by the CPU 10a, loaded into the main memory 10b by the CPU 10a, and are a unit realized through collaboration between software and hardware resources in the computer 10 shown in FIG. 2, for example.

The management node 110 uses the SSD 130 as an external memory (auxiliary memory). Here, original data of each piece of particle information to be analyzed is held in the SSD 130. Moreover, the SSD 130 is set to be accessible from (shared by) the computing nodes 120. Accordingly, the computing nodes 120 each access the SSD 130 connected to the management node 110, under the access control by the management node 110, to directly read and write data.

The data allocation unit 111 reads, from the SSD 130, data of the pieces of particle information to be analyzed, allocates the read data to the computing nodes 120, and then outputs the data files to the SSD 130. Thereby, the data files (hereinafter, particle information files) allocated to the respective computing nodes 120 are held in the SSD 130. Here, the particle information files each contain data, such as a location and an attribute of each of the corresponding particles, which are necessary for computations to be performed by the corresponding computing node 120, and are held in a format that allows the computing nodes 120 to directly read and write data. The data allocation may be performed by use of, for example, a particle division method in which particles are divided into plural groups depending on the number of the computing nodes 120 and the particles in each of the groups are allocated to one of the computing nodes 120. Alternatively, the data allocation may be performed by use of, for example, a region division method in which the region where the particles are located is divided into plural regions depending on the number of the computing nodes 120 and the particles located in each of the resultant regions are allocated to one of the computing nodes 120. In either method, when the computing nodes 120 are different in performance, the allocation of the particles may be biased depending on the difference in performance among the individual computing nodes 120.

When the computations by all the computing nodes 120 are completed, the end processing unit 112 notifies a system user of the end of the analysis. Here, the end processing unit 112 may output the results of the computations by the computing nodes 120 as the analysis results. In the first exemplary embodiment, each of the computing nodes 120 directly writes the computation results obtained by itself into the SSD 130, which will be described later in detail. Accordingly, after recognizing that the computations by all the computing nodes 120 are completed, the end processing unit 112 may simply use the data of the pieces of particle information held in the SSD 130 as the analysis results.

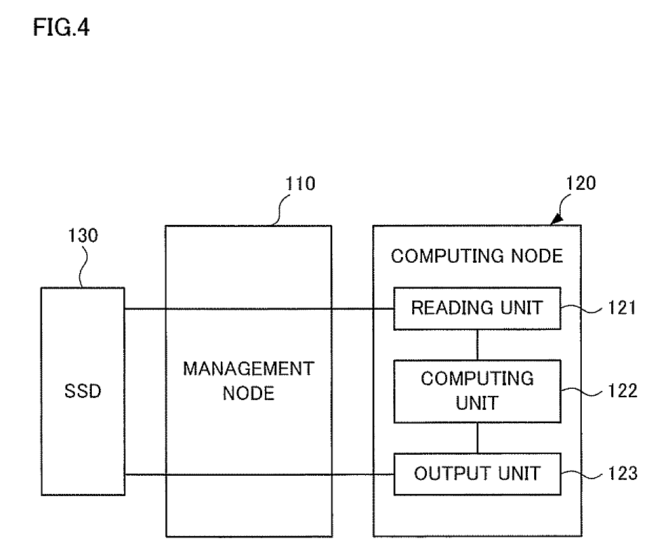

FIG. 4 is a diagram showing a functional configuration of each of the computing nodes 120.

As shown in FIG. 4, each of the computing nodes 120 is provided with a reading unit 121 that reads data to be analyzed, a computing unit 122 that performs a computing processing, and an output unit 123 that outputs the results of the computations by the computing unit 122. The reading unit 121 and the output unit 123 are realized by execution of a program, by the CPU 10a, loaded into the main memory 10b and control of the network I/F 10d. Moreover, the computing unit 122 is a function that is realized through execution of a program, by the CPU 10a, loaded into the main memory 10b. As described above, respective functional blocks of each of the computing nodes 120 shown in FIG. 4 are a unit realized through collaboration between software and hardware resources.

The reading unit 121 accesses the SSD 130 connected to the management node 110, and reads data that are necessary for computations to be performed by its own node. Here, the data that are necessary for the computations to be performed by its own node are data allocated to its own node by the management node 110 and data of other particles that affect the behavior of the particles corresponding to the data (the particles allocated to its own node). For example, the data of other particles includes data of particles which are close to the particles allocated to its own node, and thus whose electromagnetic force may affect the particles allocated to its own node or which may come in contact with the particles allocated to its own node.

The computing unit 122 analyzes the behavior of the particles allocated to its own node, on the basis of the data read by the reading unit 121. Specifically, on the basis of current positions and attributes of the particles and force acting on the particles, positional change of the particles is computed. As the attributes of the particles, sizes, masses, velocities, electric charges, magnetic charges and the like are exemplified.

The output unit 123 accesses the SSD 130 connected to the management node 110, and writes the results of the computations by the computing unit 122. The computations for the analysis of behavior on the particles by the computing unit 122 are generally executed by plural computation steps. Accordingly, the output unit 123 is to write the results of the computations every time computations are executed by the computing unit 122, to the SSD 130. At this times new results of computations may be additionally written as a new particle information file, or a particle information file allocated to its own node may be overwritten with latest results of the computations. In the former case, the results of the computations during the steps are also recorded as a history. However, since the results of the computations may not be written in the SSD 130 due to the limited memory capacity, an operation in which an older particle information file is deleted or the like in consideration of the size of the entire data may be necessary.

### <Operations of Parallel Computing System>

Next, a description will be given of operations of the parallel computing system 100 having the above configuration.

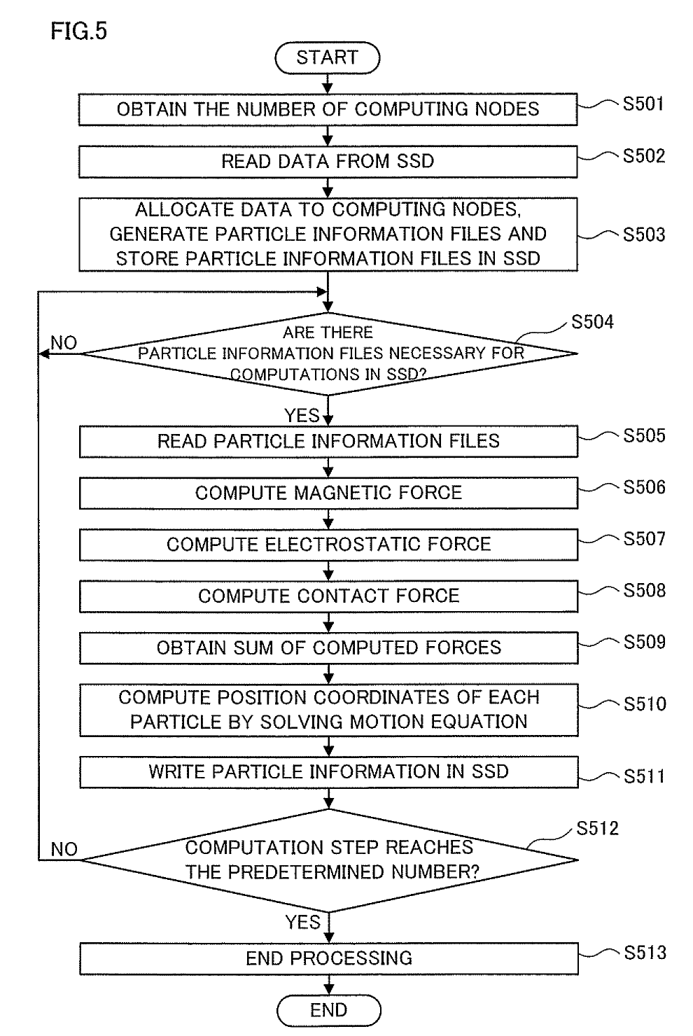

FIG. 5 is a flowchart for explaining overall operations of the parallel computing system 100 by taking, as an example, a case of performing an analysis of behavior on particles by a distinct element method.

As shown in FIG. 5, in the parallel computing system 100, the management node 110 firstly obtains the number of the computing nodes 120 (step 501), and then reads the data of the particles to be analyzed from the SSD 130 (step 502). Thereafter, the data allocation unit 111 allocates the groups of particles (data) to be analyzed to the computing nodes 120, respectively. Then, the data allocation unit 111 generates particle information files for each of the computing nodes 120, and stores the generated particle information files in the SSD 130 (step 503).

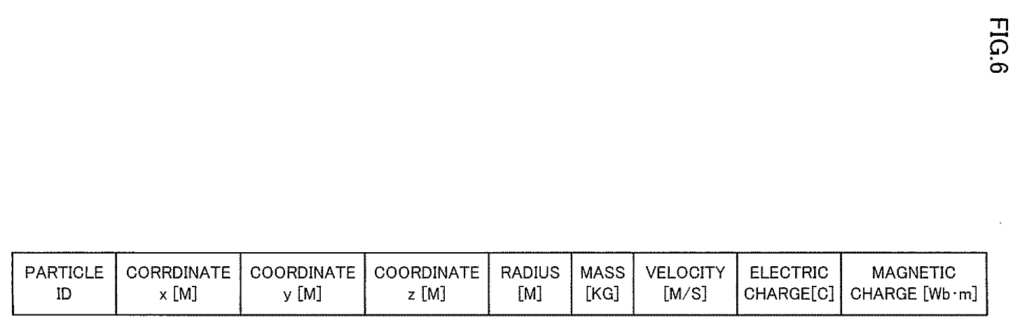

The particle information files for each of the computing nodes 120 stored in the SSD 130 each have a file name including a node ID and a step number. Here, each node ID indicates identification information of each of the computing nodes 120 to which the particle information file is allocated, and each step number indicates information on the number of the computation steps performed by each of the computing nodes 120 for each obtaining the result of the computation. FIG. 6 is a view showing an example of a data structure of a particle information file. In the example shown in FIG. 6, position information (coordinates x, y, z) and attribute information (radius, mass, velocity, electric charge, magnetic charge) of a particle, in addition to a particle ID for identifying the particle, are recorded in the particle information file.

The operations in and after step 504 are performed in each of the computing nodes 120 individually.

In each of the computing nodes 120, the reading unit 121 firstly accesses the SSD 130 to check whether there are particle information files necessary for computations to be performed by its own node (step 504). When there are particle information files necessary for the computations, the reading unit 121 reads the particle information files (step 505).

As described above, for computations to be performed by the computing unit 122 of each of the computing nodes 120, data of other particles that affect the behavior of the particles allocated to its own node are required in addition to the data of the particle information files allocated to its own node. Accordingly, it is necessary for each of the computing nodes 120 to prepare information on the particle information files required for the computations by itself (i.e. information which specifies the particle information files allocated to itself and the particle information files of other particles that affect the behavior of the particles allocated to itself). Here, any method may be used to prepare this information. Conceivable methods as simple examples are a method of creating a different data file separately from the particle information files and a method of recording the information on other particle information files in each particle information file.

In the case of employing the method of creating a different data file, in step 505, the reading unit 121 of the computing node 120 firstly specifies particle information files necessary for the computations by its own node with reference to the data file, and thereby reads the particle information files. In the case of employing the method of recording other particle information files in each particle information file, in each particle information file, information for specifying other particle information files necessary for the computations by the node to which this particle information file is allocated is recorded, in addition to the contents of the particle information file shown in FIG. 6. Then, in step 505, the reading unit 121 of the computing node 120 reads particle information files allocated to its own node, and also other particle information files necessary for the computations on the basis of the information recorded in each read particle information file.

The node IDs of the computing nodes 120 to which such other particle information files are allocated are used as information for specifying other particle information files necessary for the computations. Accordingly, other particle information files necessary for the computations are specified in the level of the computing nodes 120. The reading unit 121 of each of the computing nodes 120 first reads the particle information files allocated to its own node, and then obtains node IDs from the above-described different file or the above-described information recorded in the read particle information files. Thereafter, the reading unit 121 searches and then reads the particle information files each having any one of the obtained node IDs in the file name.

Then, the computing unit 122 of each of the computing nodes 120 performs an analysis of behavior on each particle by using the particle information files read by the reading unit 121. As the analysis method, an existing method may be used. Specifically, for example, magnetic force (magnetic interaction force), electrostatic force (electrostatic interaction force) and contact force (mechanical interaction force) are firstly computed for each particle (steps 506, 507 and 508), and the sum of the computed forces are then obtained (step 509). Thereafter, position information (position coordinates) of each particle is computed by solving a motion equation on the basis of the sum of the forces obtained in step 509 and the position information and the attribute information of the particle (step 510). Here, since the computations in steps 506 to 508 are performed independently, the computations may be performed in an order different from that shown in FIG. 5 or may be performed in parallel.

Subsequently, the output unit 123 of each of the computing nodes 120 accesses the SSD 130 to write the particle information file containing the position information computed by the computing unit 122 (step 511). The name of the particle information file includes a piece of information on the number of the computations relative to the predetermined number of the repeated computations in the analysis processing (i.e. computation step). A particle information file may be written by adding a particle information file, or by overwriting the particle information file into a new particle information file of the same particle, every time an analysis of steps 506 to 510 is completed, as described above.

The computation steps in the processing of steps 504 to 511 performed by each of the computing nodes 120 are set in advance depending on the contents of the analysis, and each of the computing nodes 120 repeats the processing until its computation step reaches the predetermined number (step 512). The reading unit 121 of each of the computing nodes 120 reads, for each computation, the particle information files of the particles allocated to its own node and other particles affecting the behavior of the particles, which contains the computation results necessary for the next computation. Here, when the output unit 123 overwrites the particle information file, there is only a single particle information file for each particle, and, hence, it is only necessary to read the particle information file.

When the computation step reaches the predetermined number, each of the computing nodes 120 terminates the processing (step 512). In the management node 110, the end processing unit 112 recognizes that the analysis processing is completed when the computation step reaches the predetermined number in all the computing nodes 120, and then performs an end processing (step 513). As the end processing, the end processing unit 112 notifies the system user of the end of the process, or outputs the particle information files held in the SSD 130 as the analysis results, for example.

Description will be further given with a specific example.

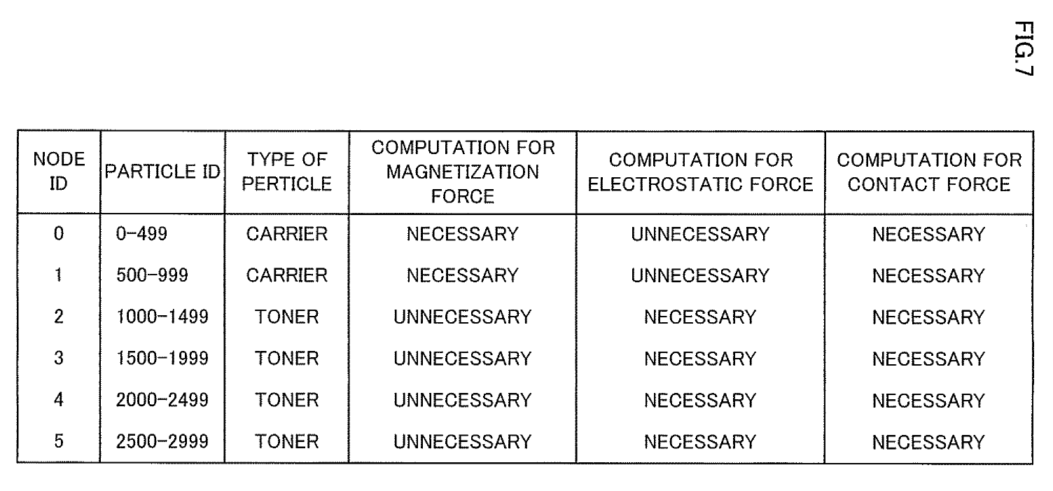

FIG. 7 is a table showing a state in which particles are allocated to the computing nodes 120.

In the example shown in FIG. 7, 500 particles out of 3000 particles are allocated to each of the six computing nodes 120. Sequential numbers 0 to 5 are given to the six computing nodes 120, respectively, as the node ID. The types of the particles are a carrier (magnetic material) and toner (non-magnetic material). There are 1000 carrier particles and 2000 toner particles. Sequential numbers 0 to 999 are given respectively to the carrier particles while sequential numbers 1000 to 2999 are given respectively to the toner particles, as the particle ID. Particles are classified depending on the type and are allocated to each of the computing nodes 120. Specifically, a particle 0 to a particle 499 are allocated to a node 0; a particle 500 to a particle 999 are allocated to a node a; a particle 1000 to a particle 1499 are allocated to a node 2; a particle 1500 to a particle 1999 are allocated to a node 3; a particle 2000 to a particle 2499 are allocated to a node 4; and a particle 2500 to a particle 2999 are allocated to a node 5.

Here, magnetic force occurs only in the carrier particles which are magnetic materials, while electrostatic force occurs only in the toner particles, each of which has an electric charge. Contact force, on the other hand, occurs in all the particles. Accordingly, in a case of computing contact force, the particle information files (results of the immediately preceding computation step) allocated to all the nodes are required to start the computation. By contrast, for example, in a case of computing magnetic force alone, only the particle information files (results of the immediately preceding computation step) allocated to the node 0 and the node 1 are required. Moreover, in a case of computing electrostatic force alone, only the particle information files (results of the immediately preceding computation step) allocated to the node 2 to the node 5 are required.

### <Another Operation Example of Parallel Computing System>

The above operation example has been described by taking, as an example, the case of performing an analysis of behavior on particles by a distinct element method. However, the parallel computing system 100 of the first exemplary embodiment is not limited to the case of employing the above-described distinct element method, and is applicable to various parallel computing using plural computing nodes 120. A description will be given of an operation example of parallel computing using a finite element method below.

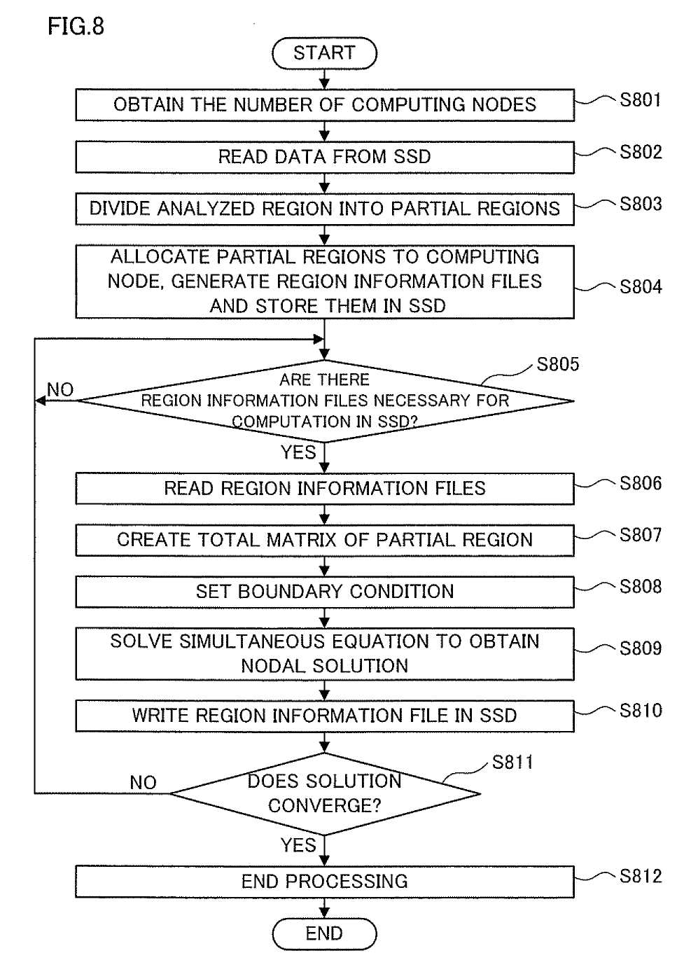

FIG. 8 is a flowchart for explaining overall operations of the parallel computing system 100 by taking, as an example, a case of performing an analysis by a finite element method.

As shown in FIG. 8, in the parallel computing system 100, the management node 110 firstly obtains the number of the computing nodes 120 (step 801), and then reads the data of an analyzed region to be analyzed from the SSD 130 (step 802). Thereafter, the data allocation unit 111 divides the analyzed region to be analyzed into partial regions (step 803). Then, the data allocation unit 111 allocates the divided partial regions to the computing nodes 120, respectively, generates region information files each containing element information of each of the partial region for the computing nodes 120, respectively, and stores the region information files in the SSD 130 (step 804).

The operations in and after step 805 are performed in each of the computing nodes 120 individually.

In each of the computing nodes 120, the reading unit 121 firstly accesses the SSD 130 to check whether there are region information files necessary for computations to be performed by its own node (step 805). When there are region information files necessary for the computations, the reading unit 121 reads the region information files (step 806). Similarly to the case of the operations shown in FIG. 5, the reading unit 121 reads region information files of other regions (adjacent regions) necessary for the analysis of the region allocated to its own node, in addition to the region information file allocated to its own node.

Then, the computing unit 122 of each of the computing nodes 120 performs a finite element analysis on each of the partial regions by using the region information files read by the reading unit 121. As an analysis method, an existing method may be used. Specifically, for example, the computing unit 122 creates, for each of the partial regions, a total matrix of the partial region on the basis of the element information of the partial region (step 807). Subsequently, the computing unit 122 sets a boundary condition on the basis of the element information of the adjacent regions (step 808). Then, a simultaneous equation is solved to obtain a nodal solution (step 809).

Thereafter, the output unit 123 of the computing node 120 accesses the SSD 130, and writes the region information file including the analysis results computed by the computing unit 122 (step 810). The analysis of steps 807 to 809 by each of the computing nodes 120 is performed repeatedly until the solution converges (step 811). The management node 110 recognizes that the analysis processing is completed when the solution has converged in all the computing nodes 120, on the basis of the region information files written in the SSD 130, and then performs an end processing (step 812).

### Second Exemplary Embodiment

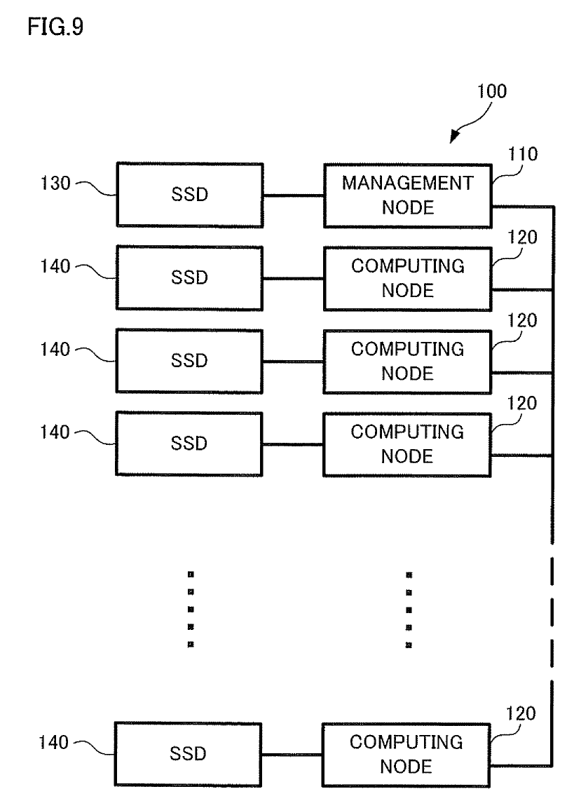

In the first exemplary embodiment, a configuration in which only the management node 110 among the nodes composing the parallel computing system 100 includes the SSD 130 is employed. However, as shown in FIG. 9, a configuration in which the computing nodes 120, in addition to the management node 110, each includes an SSD 140 as an external memory (a configuration of the parallel computing system 100 according to the second exemplary embodiment) may be employed, instead. A description will be given below of a second exemplary embodiment in which each of the computing nodes 120 is also provided with the SSD 140. The second exemplary embodiment will be described also by taking a case of performing an analysis of behavior on particles as computations (analysis processing) performed by the parallel computing system 100 as an example.

As each of the management node 110 and the computing nodes 120 in the second exemplary embodiment, for example, the computer 10 shown in FIG. 2 is used, similarly to those in the first exemplary embodiment. However, as described above, in the second exemplary embodiment, both the management node 110 and the computing nodes 120 are provided respectively with the SSD 130 and the SSDs 140, instead of a magnetic disk drive, as the external memory 10c.

<Functions of Nodes>

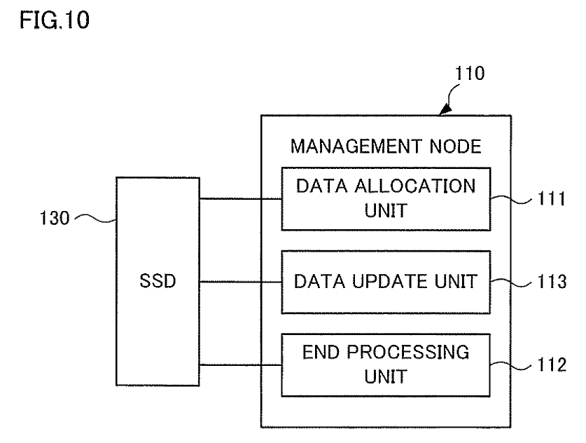

FIG. 10 is a diagram showing a functional configuration of the management node 110.

As shown in FIG. 10, the management node 110 is provided with a data allocation unit 111 that allocates data to be analyzed to each of the computing nodes 120, a data update unit 113 that receives computation results by the computing nodes 120 and updates the data to be analyzed, and an end processing unit 112 that performs an end processing after computations by all the computing nodes 120 are completed. The data allocation unit 111, the data update unit 113 and the end processing unit 112 are functions realized through execution of a program, by the CPU 10a, loaded into the main memory 10b, and are a unit realized through collaboration between software and hardware resources in the computer 10 shown in FIG. 2, for example.

The data allocation unit 111 reads, from the SSD 130, data of the pieces of particle information to be analyzed, allocates the read data to the computing nodes 120, and then transmits the allocated data to the computing nodes 120. Here, the data transmitted to each of the computing nodes 120 contain data, such as a location and an attribute of each of the corresponding particles, which are necessary for computations to be performed by each of the computing nodes 120. The data allocation may be performed by use of a conventional method such as a particle division method or a region division method. Moreover, the data allocation unit 111 transmits data of other particles that affect the behavior of the particles (the particles allocated to its own node) corresponding to the data together with the allocated data to each of the computing nodes 120. The data of other particles are data that are necessary for performing the analysis of the behavior on particles by each of the computing nodes 120 (data that are necessary for the computations).

The data update unit 113 receives computation results of the computing nodes 120, and then forms analysis results from the received computation results. Then, the data update unit 113 updates the pieces of particle information held in the SSD 130. This particle information update by the SSD 130 may be performed by writing the analysis results additionally, or by overwriting the current pieces of particle information with the analysis results. Computations for an analysis of behavior on particles by each of the computing nodes 120 are performed through plural computation steps, in general. Accordingly, the data update unit 113 updates the corresponding piece of particle information every time a computation result of a computation step is received from each of the computing nodes 120.

When the number of the computation steps performed by the computing nodes 120 reaches the predetermined number, the end processing unit 112 notifies a system user of the end of the analysis.

Here, the end processing unit 112 may output final analysis results (updated information). In the second exemplary embodiment, the data update unit 113 writes, as the analysis results, the computation results by all the computing nodes 120 collectively into the SSD 130. Accordingly, in the case of outputting the analysis results, the end processing unit 112 may simply output the data of the pieces of particle information held in the SSD 130.

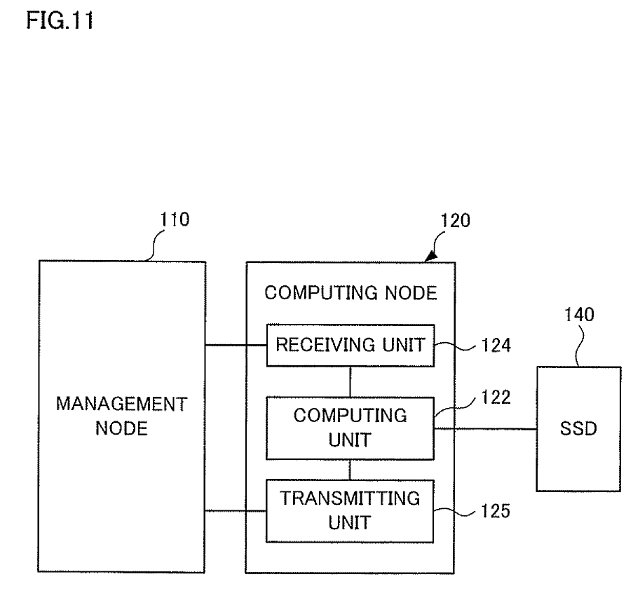

FIG. 11 is a diagram showing a functional configuration of each of the computing nodes 120.

As shown in FIG. 11, each of the computing nodes 120 is provided with a receiving unit 124 that receives data to be analyzed from the management node 110, a computing unit 122 that executes a computing processing, and a transmitting unit 125 that transmits computation results by the computing unit 122 to the management node 110. The receiving unit 124 and the transmitting unit 125 are realized by execution of the program, by the CPU 10a, loaded into the main memory 10b and control of the network I/F 10d in the computer 10 shown in FIG. 2, for example. The computing unit 122 is a function that is realized by execution of the program, by the CPU 10a, loaded into the main memory 10b. As described above, respective functional blocks in each of the computing nodes 120 shown in FIG. 11 are a unit that is realized through collaboration between software and hardware resources.

The receiving unit 124 receives data that are necessary for the computations by its own node transmitted from the management node 110. Here, the data necessary for the computations by its own node are, as described above, the data allocated to its own node by the management node 110 and data of other particles that affect behavior of the particles (the particles allocated to its own node) corresponding to the data.

The computing unit 122 analyzes the behavior of the particles allocated to its own node on the basis of the received data by the receiving unit 124. The computing unit 122 causes the work file created during the execution of the computations for the analysis to be held not only in the internal memory of the CPU 10a and the main memory 10b but also in the SSD 140.

The transmitting unit 125 transmits computation results by the computing unit 122 to the management node 110. As described above, generally, the computations for the analysis of behavior on particles by the computing unit 122 is executed as plural computation steps. Accordingly, the transmitting unit 125 is to transmit computation results to the management node 110 every time computation is executed by the computing unit 122.

### <Operations of Parallel Computing System>

Next, a description will be given of operations of the parallel computing system 100 according to the second exemplary embodiment.

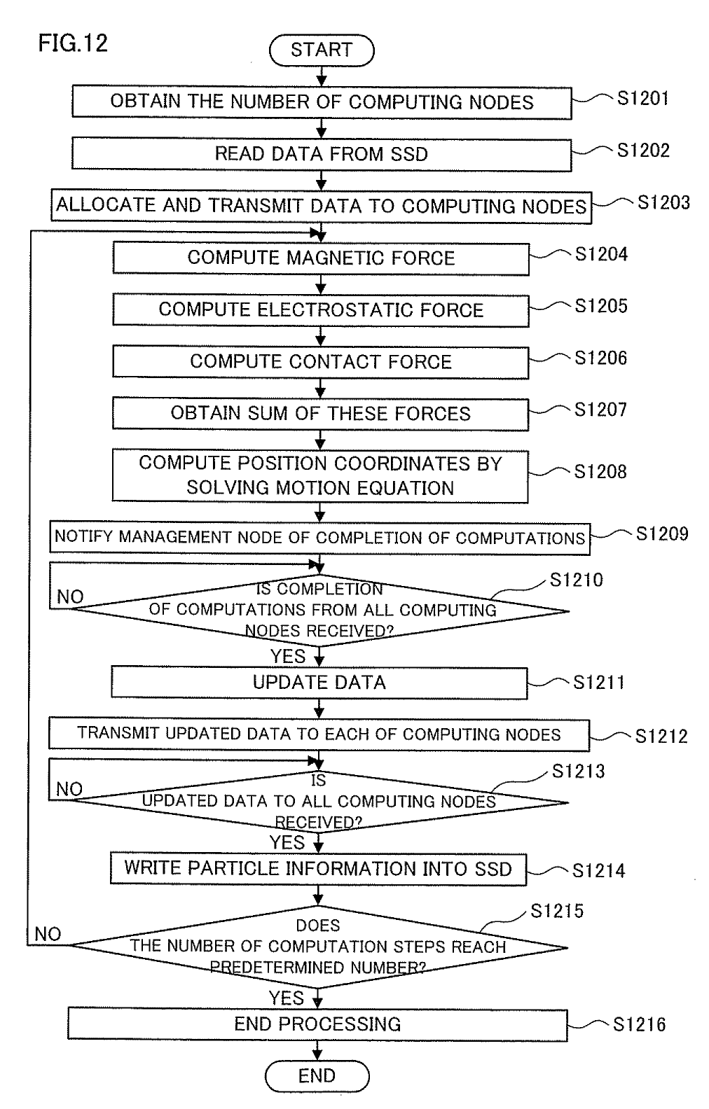

FIG. 12 is a flowchart for explaining overall operations of the parallel computing system 100 by taking, as an example, a case of performing an analysis of behavior on particles by a distinct element method.

As shown in FIG. 12, in the parallel computing system 100, the management node 110 firstly obtains the number of the computing nodes 120 (step 1201), and then reads the data of the particles to be analyzed from the SSD 130 (step 1202). Thereafter, the data allocation unit 111 allocates the groups of particles (data) to be analyzed to the computing nodes 120, respectively. Then, the data allocation unit 111 transmits data of the allocated particles to the computing nodes 120, respectively (step 1203). The transmitted data is received by the receiving unit 124 of each of the computing nodes 120, and the data is transmitted to the computing unit 122.

The operations in steps 1204 to 1209 are performed in each of the computing nodes 120 individually.

In each of the computing nodes 120, the computing unit 122 firstly computes magnetic force (magnetic interaction force), electrostatic force (electrostatic interaction force) and contact force (mechanical interaction force) for each particle (steps 1204, 1205 and 1206). At that time, the computed magnetic force, electrostatic force and contact force are outputted as a work file, and the file is held in the SSD 140. Then, the computing unit 122 reads the magnetic force, electrostatic force and contact force that are held as a work file from the SSD 140, and the sum of these forces are then obtained (step 1207). Thereafter, position information (position coordinates) of each particle is computed by solving a motion equation on the basis of the sum of the forces obtained in step 1207 and the position information and the attribute information of the particle (step 1208). When the computations by the computing unit 122 are completed, the transmitting unit 125 notifies the management node 110 of completion of the computations (step 1209).

After the data updating unit 113 of the management node 110 receives a notification of the completion of the computations from all the computing nodes 120, the data updating unit 113 receives computation results from each of the management nodes 110, and updates the data read from the SSD 130 in step 1202 (step 1210 and 1211). Then, in order to use the updated data for the next computation step by each of the computing nodes 120, the data updating unit 113 transmits the updated data to each of the computing nodes 120 (step 1212). After transmitting the updated data to all the computing nodes 120, the data updating unit 113 writes the computation results (the particle information) of each of the computing nodes 120 into the SSD 130 (step 1213 and 1214). Then, the processings of the steps 1204 to 1214 are repeated until the number of the computation steps of each of the computing nodes 120 reaches the predetermined number (step 1215). When the number of the computation steps reaches the predetermined number, the end processing unit 112 executes end processing in which the computation result outputted in step 1214 is provided as an analysis result (step 1216).

### <Another Operational Example of Parallel Computing System>

The second exemplary embodiment is not limited to the above-described analysis of behavior on particles by the distinct element method, and may be applied to various kinds of parallel computations that are executed by using plural computing nodes 120. Next, a description will be given of another operational example of the parallel computation by using the finite element method.

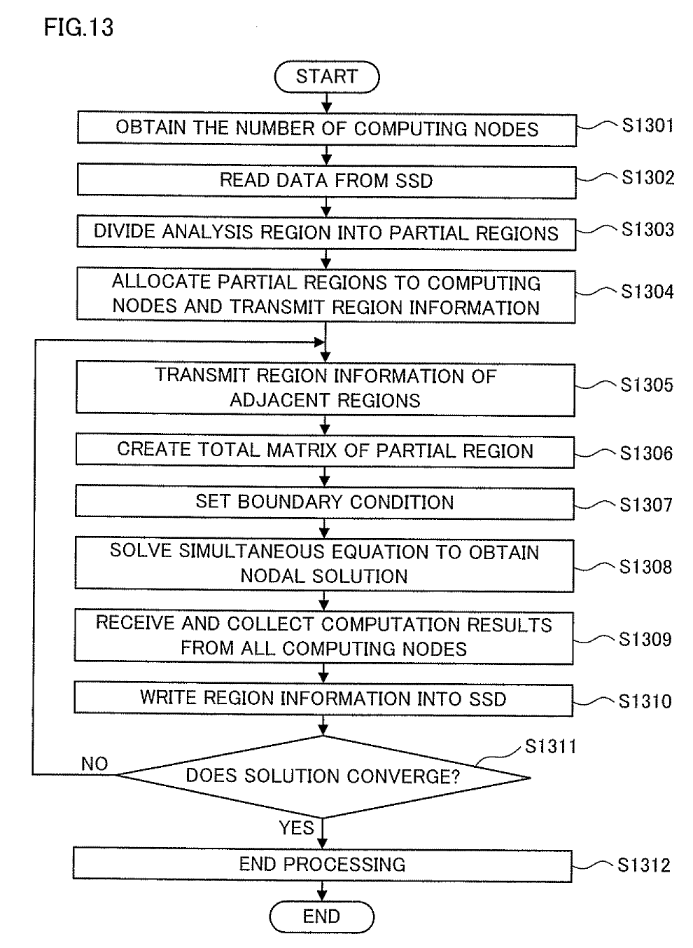

FIG. 13 is a flowchart for explaining overall operations of the parallel computing system 100 by taking, as an example, a case of performing a finite element analysis.

As shown in FIG. 13, in the parallel computing system 100, the management node 110 firstly obtains the number of the computing nodes 120 (step 1301), and then reads the data of an analysis region to be analyzed from the SSD 130 (step 1302). Thereafter, the data allocation unit 111 divides the analysis region into partial regions (step 1303), allocates the divided partial regions to the computing nodes 120, respectively, and transmits data (region information) of the allocated partial regions to the computing nodes 120, respectively (step 1304). Then, the data allocation unit 111 transmits data (region information) of partial regions (adjacent regions) adjacent to the allocated partial region to the computing nodes 120, respectively (step 1305).

The operations of steps 1306 to 1308 are performed in each of the computing nodes 120 independently.

In each of the computing nodes 120, the computing unit 122 firstly creates, for each of the partial regions, a total matrix of the partial region on the basis of the element information of the partial region (step 1306). Subsequently, the computing unit 122 sets a boundary condition on the basis of the element information of the adjacent regions (step 1307). Then, a simultaneous equation is solved to obtain a nodal solution (step 1308). In this event, the computation results (the total matrix of the partial region, the boundary condition, and the nodal solution) obtained in the respective steps are each outputted as a work file, and the outputted files are held in the SSD 140 of its own node. When the computations by the computing unit 122 are completed, the transmission unit 125 transmits the computation results to the management node 110.

The data update unit 113 of the management node 110 receives and collects the computation results from all the computing nodes 120 (step 1309), and then writes the results (region information) into the SSD 130 as analysis results (step 1310). The management node 110 and the computing nodes 120 repeat the operations of steps 1305 to 1310 until the solution of the analysis result converges (step 1311). When the solution of the analysis result has converged in all the computing nodes 120, the management node 110 performs an end processing (step 1312).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A parallel computing system comprising:
a plurality of computing nodes that perform a computation;
a management node that is connected to the plurality of computing nodes, and that manages parallel computing by the plurality of computing nodes; and
an external memory that is connected to the management node, that is accessible from the management node and the plurality of computing nodes, and that uses a semiconductor memory as a memory medium,
the management node allocating data to be processed to each of the computing nodes, and creating an individual data file for each of the computing nodes in the external memory, and
each of the computing nodes performing a computation by accessing the external memory and by reading the data file allocated to itself and a different data file to be referenced in a computation using the allocated data file, and outputting a computation result to the external memory.

2. The parallel computing system according to claim 1, wherein
the management node creates specifying information that specifies the data file necessary for a computation for each of the computing nodes, and causes the created specifying information to be held in the external memory, and
each of the computing nodes accesses the external memory, and reads the data file allocated to itself and the different data file, on the basis of the specifying information.

3. The parallel computing system according to claim 1, wherein
the management node writes, in the data file allocated to each of the computing nodes, specifying information that specifies the data file necessary for a computation of each of the computing nodes, and
each of the computing nodes accesses the external memory, reads the data file allocated to itself, and reads the different data file on the basis of the specifying information written in the data file.

4. The parallel computing system according to claim 1, wherein
the management node allocates a plurality of particles to be analyzed to the plurality of computing nodes, and creates the data file that contains position information and attribute information on one of the allocated particles, and
each of the computing nodes reads the data file allocated to itself and the different data file, and performs an analysis of behavior on the particles corresponding to the data file allocated to itself.

5. The parallel computing system according to claim 1, wherein
the management node divides a region to be analyzed into a plurality of partial regions, allocates the partial regions to the plurality of computing nodes, and creates the data file that contains element information on one of the allocated partial regions, and
each of the computing nodes reads the data file allocated to itself and the different data file, and performs a finite element analysis on one of the partial regions corresponding to the data file allocated to itself.

6. The parallel computing system according to claim 1, wherein
the plurality of computing nodes each include an external memory using a semiconductor memory as a memory medium, and
each of the computing nodes causes a work file created while performing the computation to be held in the external memory.

7. A parallel computing system comprising:
a plurality of computing nodes that perform a computation; and
a management node that is connected to the plurality of computing nodes, and that manages parallel computing by the plurality of computing nodes,
the computing nodes and the management node each including an external memory that uses a semiconductor memory as a memory medium,
the management node allocating and transmitting data to be processed to the computing nodes, and
each of the computing nodes performing a computation by using data received from the management node, and causing a work file created while performing the computation to be held in the external memory included in itself.

8. The parallel computing system according to claim 7, wherein
the management node allocates a plurality of particles to be analyzed to the plurality of computing nodes, and transmits the data of one of the allocated particles to each of the computing nodes, and
each of the computing nodes performs an analysis of behavior on one of particles allocated to itself, by using the data received from the management node, and causes a work file created while performing the analysis processing to be held in the external memory of itself.

9. The parallel computing system according to claim 7, wherein
the management node divides a region to be analyzed into a plurality of partial regions, allocates the partial regions to the plurality of computing nodes, and transmits the data of one of the partial regions to each of the computing nodes, and
each of the computing nodes performs a finite element analysis on the one of the partial regions allocated to itself, by using the data received from the management node, and then causes a work file created while performing the analysis processing to be held in the external memory of itself.

10. A parallel computing method comprising:
causing a management node to allocate data to be processed to a plurality of computing nodes, to create an individual data file for each of the computing nodes, and write the data file into an external memory connected to the management node and using a semiconductor memory as a memory medium;
causing each of the computing nodes to access the external memory, and to read the data file, if the data file allocated to itself and a different data file to be referenced in a computation using the allocated data file are present; and
causing each of the computing nodes to access the external memory, and to write a result of the computation using the read data file into the external memory.
